(19) United States
(12) Patent Application Publication
(10) Pub. No.: US 2025/0391330 A1
(43) Pub. Date: Dec. 25, 2025

(54) DISPLAY DEVICE AND ELECTRONIC DEVICE INCLUDING THE SAME

(71) Applicant: Samsung Display Co., Ltd., Yongin-si (KR)

(72) Inventor: Gi Chang LEE, Yongin-si (KR)

(21) Appl. No.: 19/096,513

(22) Filed: Mar. 31, 2025

(30) Foreign Application Priority Data
Jun. 20, 2024 (KR) 10-2024-0080001
Aug. 29, 2024 (KR) 10-2024-0116693

(51) Int. Cl. G09G 3/32

(52) U.S. Cl. CPC G09G 3/32; G09G 2310/0275; G09G 2310/0286; G09G 2310/0289; G09G 2310/0291; G09G 2310/0297; G09G 2310/08; G09G 2330/021

(57) ABSTRACT

A display device includes: a display panel including a pixel connected to a data line, the display panel being configured to display an image; and a data driver configured to provide a data signal to the data line, wherein the data driver includes: a shift register configured to generate a sampling signal; a sampling latch configured to latch image data in response to the sampling signal; a holding latch configured to store an output of the sampling latch; a decoder configured to convert an output of the holding latch into an analog signal; and a buffer configured to provide an output of the decoder to the data line, and wherein the sampling latch is integrated in a first chip different from the display panel, and wherein the buffer is integrated in the display panel.

### CROSS-REFERENCE TO RELATED APPLICATIONS

The present application claims priority to and the benefit of Korean Patent Application No. 10-2024-0080001, filed on Jun. 20, 2024, and Korean Patent Application No 10-2024-0116693, filed on Aug. 29, 2024, in the Korean Intellectual Property Office, the entire disclosures of each of which are incorporated herein by reference.

### BACKGROUND

### 1. Field

Aspects of some embodiments of the present disclosure generally relate to a display device and an electronic device including the same.

### 2. Description of the Related Art

A display device includes a data driver for supplying a data signal to data lines, a gate driver for supplying a gate signal to gate lines, and pixels located to be connected to the data lines and the gate lines.

The above information disclosed in this Background section is only for enhancement of understanding of the background and therefore the information discussed in this Background section does not necessarily constitute prior art.

### SUMMARY

Aspects of some embodiments include a display device and an electronic device including the same, which can relatively reduce costs (e.g., manufacturing or product costs).

According to some embodiments of the present disclosure, a display device includes: a display panel including a pixel connected to a data line, the display panel displaying an image; and a data driver configured to provide a data signal to the data line, wherein the data driver includes: a shift register configured to generate a sampling signal; a sampling latch configured to latch image data in response to the sampling signal; a holding latch configured to store an output of the sampling latch; a decoder configured to convert an output of the holding latch into an analog signal; and a buffer configured to provide an output of the decoder to the data line, and wherein the sampling latch is integrated in a first chip different from the display panel, and the buffer is integrated in the display panel.

According to some embodiments, the first chip may include a low voltage element having a node level higher than a node level of a high voltage element integrated in the display panel, and may not include the high voltage element.

According to some embodiments, the display panel may be implemented as a chip different from the first chip.

According to some embodiments, the decoder and the holding latch may be integrated together with the buffer in the display panel.

According to some embodiments, the data driver may further include a level shifter connected between the sampling latch and the holding latch. According to some embodiments, the level shifter may be integrated in the display panel.

According to some embodiments, the data driver may further include a first multiplexer and a first demultiplexer, which are connected between the sampling latch and the level shifter. According to some embodiments, the first multiplexer may be integrated in the first chip, and the first demultiplexer may be integrated in the display panel.

According to some embodiments, the holding latch and the decoder may be integrated in the first chip.

According to some embodiments, the data driver may further include a level shifter connected between the decoder and the buffer. According to some embodiments, the level shifter may be integrated in the display panel.

According to some embodiments, the display device may further include a timing controller configured to provide image data to the data driver. According to some embodiments, the timing controller may be integrated in a second chip different from the first chip.

According to some embodiments, the display device may further include a timing controller configured to provide image data to the data driver. According to some embodiments, the timing controller may be integrated in the first chip.

According to some embodiments of the present disclosure, a display device includes: a display panel including a pixel connected to a data line, the display panel displaying an image; and a data driver configured to provide a data signal to the data line, wherein the data driver includes: a shift register configured to generate a sampling signal; a sampling latch configured to latch image data in response to the sampling signal; a holding latch configured to store an output of the sampling latch; a decoder configured to convert an output of the holding latch into an analog signal; and a buffer configured to provide an output of the buffer to the data line, and wherein the data driver further includes a level shifter electrically connected between the sampling latch and the holding latch.

According to some embodiments, the sampling latch may be implemented with a low voltage element. According to some embodiments, the level shifter and the holding latch may be implemented with a high voltage element having a node level lower than a node level of the low voltage element.

According to some embodiments, the data driver may further include a first multiplexer and a first demultiplexer, which are connected between the sampling latch and the level shifter.

According to some embodiments of the present disclosure, there is provided an electronic device including: a processor configured to output input image data; and a display device configured to display an image, based on the input image data, wherein the display device includes: a display panel including a pixel connected to a data line; a timing controller configured to convert the input image data into image data corresponding to an arrangement of the pixel in the display panel; and a data driver configured to generate a data signal, based on the image data, and provide the data signal to the data line, wherein the data driver includes: a shift register configured to generate a sampling signal; a sampling latch configured to latch image data in response to the sampling signal; a holding latch configured to store an output of the sampling latch; a decoder configured to convert an output of the holding latch into an analog signal; and a buffer configured to provide an output of the decoder to the data line, and wherein the sampling latch is integrated in a first chip different from the display panel, and the buffer is integrated in the display panel.

According to some embodiments, the first chip may include a low voltage element having a node level higher than a node level of a high voltage element integrated in the display panel, and may not include the high voltage element.

According to some embodiments, the decoder and the holding latch may be integrated together with the buffer in the display panel.

According to some embodiments, the data driver may further include a level shifter connected between the sampling latch and the holding latch. According to some embodiments, the level shifter may be integrated in the display panel.

According to some embodiments, the data driver may further include a first multiplexer and a first demultiplexer, which are connected between the sampling latch and the level shifter. According to some embodiments, the first multiplexer may be integrated in the first chip, and the first demultiplexer may be integrated in the display panel.

According to some embodiments, the holding latch and the decoder may be integrated in the first chip.

According to some embodiments, the data driver may further include a level shifter connected between the decoder and the buffer. According to some embodiments, the level shifter may be integrated in the display panel.

### BRIEF DESCRIPTION OF THE DRAWINGS

Aspects of some embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a block diagram illustrating a display device according to some embodiments of the present disclosure.

FIG. 2A is a plan view illustrating further details of the display device shown in FIG. 1.

FIG. 2B is a sectional view illustrating further details of the display device taken along the line I-I′ shown in FIG. 2A.

FIG. 2C is a plan view illustrating further details of the display device shown in FIG. 1.

FIG. 3 is an exploded perspective view illustrating a portion of a display panel shown in FIG. 1.

FIG. 4 is a diagram illustrating aspects of components of a data driver shown in FIG. 1.

FIG. 5 is a plan view illustrating further details of the display device shown in FIG. 1.

FIGS. 6 and 7 are block diagrams illustrating aspects of a data driver included in the display device shown in FIG. 5.

FIG. 8 is a block diagram illustrating a comparative example of the data driver included in the display device shown in FIG. 5.

FIG. 9 is a block diagram illustrating aspects of the data driver included in the display device shown in FIG. 5.

FIG. 10 is a block diagram illustrating aspects of the data driver included in the display device shown in FIG. 5.

FIG. 11 is a block diagram illustrating a display system according to some embodiments.

FIGS. 12 to 14 are perspective views illustrating application examples of the display system shown in FIG. 11.

### DETAILED DESCRIPTION

Hereinafter, aspects of some embodiments of the present disclosure will be described in more detail with reference to the accompanying drawings. In the description below, only a necessary part to understand an operation according to the present disclosure is described and the descriptions of other parts are omitted in order not to unnecessarily obscure subject matters of the present disclosure. In addition, the present disclosure is not limited to the embodiments described herein, but may be embodied in various different forms. Rather, aspects of embodiments described herein are provided to more thoroughly and completely describe the disclosed contents and to sufficiently transfer the ideas of the disclosure to a person of ordinary skill in the art.

In the entire specification, when an element is referred to as being “connected” or “coupled” to another element, it can be directly connected or coupled to the another element or be indirectly connected or coupled to the another element with one or more intervening elements interposed therebetween. The technical terms used herein are used only for the purpose of illustrating a specific embodiment and not intended to limit the embodiment. It will be understood that when a component “includes” an element, unless there is another opposite description thereto, it should be understood that the component does not exclude another element but may further include another element. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Similarly, for the purposes of this disclosure, “at least one selected from the group consisting of X, Y, and Z” can be construed as X only, Y only, Z only, or any combination of two or more items X, Y, and Z (e.g., XYZ, XYY, YZ, ZZ).

It will be understood that, although the terms “first”, “second,” etc. may be used herein to describe various elements, these elements should not be limited by these terms. These terms are only used to distinguish one element from another element. Thus, a “first” element discussed below could also be termed a “second” element without departing from the teachings of the present disclosure.

Spatially relative terms, such as “below,” “above,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the term, “above,” may encompass both an orientation of above and below. The apparatus may be otherwise oriented (e.g., rotated 90 degrees or at other orientations) and the spatially relative descriptors used herein interpreted accordingly.

In addition, the embodiments of the disclosure are described here with reference to schematic diagrams of ideal embodiments (and an intermediate structure) of the present disclosure, so that changes in a shape as shown due to, for example, manufacturing technology and/or a tolerance may be expected. Therefore, the embodiments of the present disclosure shall not be limited to the specific shapes of a region shown here, but include shape deviations caused by, for example, the manufacturing technology. The regions shown in the drawings are schematic in nature, and the shapes thereof do not represent the actual shapes of the regions of the device, and do not limit the scope of the disclosure.

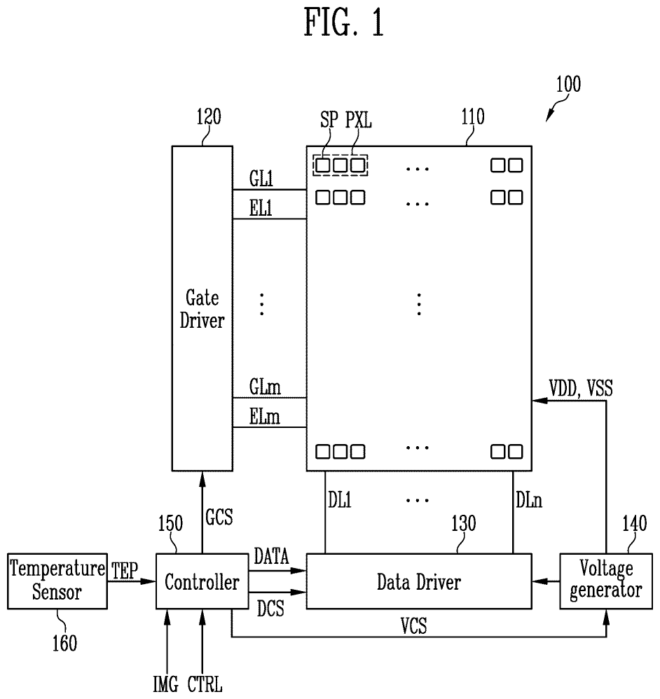

FIG. 1 is a block diagram illustrating a display device according to some embodiments of the present disclosure.

Referring to FIG. 1, the display device 100 may include a display panel 110, a gate driver 120, a data driver 130, a voltage generator 140, and a controller 150.

The display panel 110 may include sub-pixels SP. The sub-pixels SP may be connected to the gate driver 120 through first to mth gate lines GL1 to GLm. The sub-pixels SP may be connected to the data driver 130 through first to nth data lines DL1 to DLn.

Each of the sub-pixels SP may include at least one light emitting element configured to generate light. Accordingly, each of the sub-pixels SP may generate light of a specific color such as red, green, blue, cyan, magenta or yellow. Two or more sub-pixels among the sub-pixels SP may constitute one pixel PXL. For example, three sub-pixels SP may constitute one pixel PXL as shown in FIG. 1. According to some embodiments, four sub-pixels SP may constitute one pixel PXL.

The gate driver 120 may be connected to the sub-pixels SP arranged in a row direction through the first to mth gate lines GL1 to GLm. The gate driver 120 may output gate signals to the first to mth gate lines GL1 to GLm in response to a gate control signal GCS. According to some embodiments, the gate control signal GCS may include a start signal indicating a start of each frame, a horizontal synchronization signal for outputting gate signals in synchronization with timings at which data signals are applied, and the like.

According to some embodiments, first to mth emission control lines EL1 to ELm connected to the sub-pixels SP in the row direction may be further provided. The gate driver 120 may include an emission control driver configured to control the first to mth emission control lines EL1 to ELm, and the emission control driver may operate under the control of the controller 150.

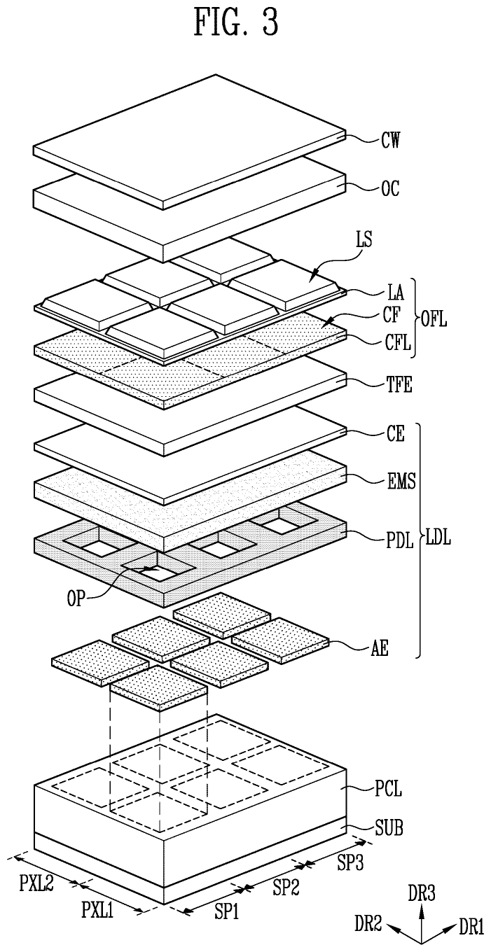

The gate driver 120 may be located at one side of the display panel 110. However, embodiments according to the present disclosure are not limited thereto. For example, the gate driver 120 may be divided into two or more drivers which are physically and/or logically divided, and these drivers may be located at one side of the display panel 110 and an opposite side of the display panel 110, which is opposite to the one side (see FIG. 5). As such, in some embodiments, the gate driver 120 may be arranged or formed in various forms at the periphery of the display panel 110.

The data driver 130 may be connected to the sub-pixels SP arranged in a column direction through the first to nth data lines DL1 to DLn. The data driver 130 may receive image data DATA and a data control signal DCS from the controller 150. The data driver 130 may operate in response to the data control signal DCS. According to some embodiments, the data control signal DCS may include a source start pulse, a source shift clock, a source output enable signal, and the like.

The data driver 130 may apply data signals having grayscale voltages corresponding to the image data DATA to the first to nth data lines DL1 to DLn by using voltages from the voltage generator 140. When a gate signal is applied to each of the first to mth gate lines GL1 to GLm, data signals corresponding to the image data DATA may be applied to the data lines DL1 to DLm. Accordingly, corresponding sub-pixels SP may generate light corresponding to the data signals. Accordingly, an image may be displayed on the display panel 110.

According to some embodiments, the gate driver 120 and the data driver 130 may include complementary metal-oxide semiconductor (CMOS) circuit elements.

The voltage generator 140 may operate in response to a voltage control signal VCS from the controller 150. The voltage generator 140 may be configured to generate a plurality of voltages and provide the generated voltages to components of the display device 100. For example, the voltage generator 140 may be configured to generate a plurality of voltages by receiving an input voltage from an outside of the display device 100, adjusting the received voltage, and regulating the adjusted voltage.

The voltage generator 140 may generate a first power voltage VDD and a second power voltage VSS, and the generated first and second power voltages VDD and VSS may be provided to the sub-pixels SP. The first power voltage VDD may have a relatively high voltage level, and the second power voltage VSS may have a voltage level lower than the voltage level of the first power voltage VDD. According to some embodiments, the first power voltage VDD or the second power voltage VSS may be provided by an external device of the display device 100.

Besides, the voltage generator 140 may generate various voltages. For example, the voltage generator 140 may generate an initialization voltage applied to the sub-pixels SP. For example, a reference voltage (e.g., a set or predetermined reference voltage) may be applied to the first to nth data lines DL1 to DLn in a sensing operation for sensing electrical characteristics of transistors and/or light emitting elements of the sub-pixels SP, and the voltage generator 140 may generate the reference voltage.

The controller 150 may control overall operations of the display device 100. The controller 150 may receive, from the outside, input image data IMG and a control signal CTRL for controlling display thereof. The controller 150 may provide the gate control signal GCS, the data control signal DCS, and the voltage control signal VCS in response to the control signal CTRL. The controller 150 may include a timing control circuit (or timing controller) which performs the above-described function.

The controller 150 may convert the input image data IMG to be suitable for the display device 100 or the display panel 110, thereby outputting the image data DATA. According to some embodiments, the controller 150 may align the input image data IMG to be suitable for the sub-pixels SP (e.g., arrangement or disposition of the sub-pixels SP) in units of rows, thereby outputting the image data DATA. The controller 150 may include a data conversion circuit which performs the above-described function.

Besides, the controller 150 may further include an interface conversion circuit and a data compensation circuit. The interface conversion circuit may convert a data format of the image data DATA to be suitable for interface specification with the data driver 130, output the image data DATA in the converted data format. The data compensation circuit (or image processing circuit) may compensate for the image data DATA such that an image is displayed with a desired luminance according to a characteristic of the display device 100, a setting of a user, or the like, or convert the image data DATA for the purpose of reduction of power consumption, afterimage compensation, or the like.

The display device 100 may include at least one temperature sensor 160. The temperature sensor 160 may be configured to sense a temperature at the periphery thereof and generate temperature data TEP indicating the sensed temperature.

The controller 150 may control various operations of the display device 100 in response to the temperature data TEP. According to some embodiments, the controller 150 may adjust the luminance of an image output from the display panel 110 in response to the temperature data TEP. For example, the controller 150 may control components such as the data driver 130 and/or the voltage generator 140, thereby adjusting data signals and the first and second power voltages VDD and VSS.

Two or more components among the data driver 130, the voltage generator 140, and the controller 150 may be configured into one integrated circuit.

According to some embodiments, the controller 150 may be configured as one integrated circuit, and be arranged on a printed circuit board.

According to some embodiments, the data driver 130 and the controller 150 may be configured into one integrated circuit, and be arranged on a printed circuit board. The data driver 130 and the controller 150 may be components functionally divided in one integrated circuit.

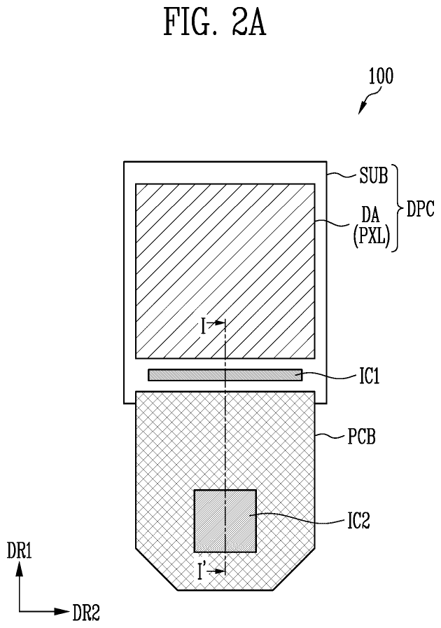

FIG. 2A is a plan view illustrating further details of the display device shown in FIG. 1. FIG. 2B is a sectional view illustrating further details of the display device taken along the line I-I′ shown in FIG. 2A. FIG. 2C is a plan view illustrating further details of the display device shown in FIG. 1.

Referring to FIGS. 2A and 2B, a substrate SUB may include a display area DA. At least one pixel PXL may be located in the display area DA, and an image may be displayed through the display area DA. The substrate SUB and the pixel PXL may constitute a display panel or a panel chip DPC.

A non-display area may be located at the periphery (e.g., surrounding or outside a footprint) of the display area DA, and a component for controlling the pixel PXL may be located in the non-display area. For example, at least one of the gate driver 120, the data driver 130, the voltage generator 140, or the controller 150, which are shown in FIG. 1, may be located in the non-display area of the panel chip DPC.

According to some embodiments, a portion of the data driver 130 shown in FIG. 1 may be implemented as a first integrated circuit IC1 (or first chip) different from the panel chip DPC, and the first integrated circuit IC1 may be mounted on the substrate SUB or the panel chip DPC. The other portion of the data driver 130 may be located in the non-display area of the substrate SUB or be implemented in the panel chip DPC. For example, the first integrated circuit IC1 may be manufactured independently from the panel chip DPC, and be attached to the panel chip DPC through a module process. For example, when the substrate SUB is a silicon wafer substrate formed using a semiconductor process, the first integrated circuit IC1 may be attached to the substrate SUB, using a chip on silicon method.

Although will be described later with reference to FIGS. 5 to 10, the display device 100 may include a high voltage element of which node level is low and a low voltage element of which node level is high, the panel chip DPC may be configured to include only the high voltage element, and the first integrated circuit IC1 may be configured to the low voltage element. That the node level is low may mean that a technique used in the semiconductor process is detailed, and the low voltage element having the high node level may have a transistor size and a circuit distance, which are smaller than a transistor size and a circuit distance of the high voltage element having the low node level. For example, the transistor size or circuit distance of the low voltage element may be about 22 nm to 40 nm, and the transistor size or circuit distance of the high voltage element may be about 100 nm to 300 nm or about 45 nm to 180 nm. While the low voltage element provides high performance and energy efficiency, manufacturing cost of the low voltage element may be high as compared with the high voltage element. Manufacturing cost of a chip including both the high voltage element and the low voltage element may be higher. Meanwhile, when the first integrated circuit IC1 includes only the low voltage element, cost of the first integrated circuit IC1 may be lowered.

According to some embodiments, the controller shown in FIG. 1 may be implemented as a second integrated circuit IC2 (or second chip), and the second integrated circuit IC2 may be mounted on a printed circuit board PCB and be connected to the first integrated circuit IC1 (or the data driver 130 shown in FIG. 1) through the printed circuit board PCB.

However, the controller 150 shown in FIG. 1 is not limited thereto. For example, the controller 150 shown in FIG. 1 along with a portion of the data driver 130 may be implemented as the first integrated circuit IC1. For example, when the controller 150 does not include the data compensation circuit (e.g., a circuit which converts image data for the purpose of reduction of power consumption, afterimage compensation, or the like), the controller 150 may be implemented in the first integrated circuit IC1. For example, the first integrated circuit IC1 may be a timing controller embedded driver IC. As shown in FIG. 20, the display device 100 does not include the second integrated circuit IC2 shown in FIG. 2A.

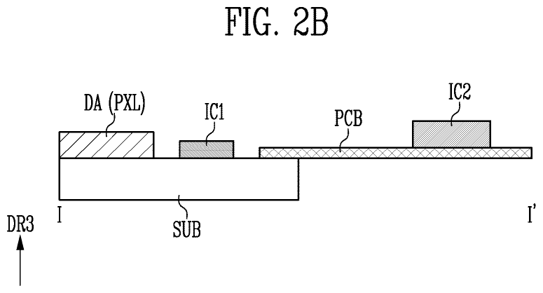

FIG. 3 is an exploded perspective view illustrating a portion of the display panel shown in FIG. 1. In FIG. 3, for clear and brief description, a portion of the display panel 110, which corresponds to two pixels PXL1 and PXL2, may be schematically illustrated. A portion of the display panel 110, which corresponds to the other pixels, may also be configured identically to the portion of the display panel 110, which corresponds to the two pixels PXL1 and PXL2.

Referring to FIG. 3, each of first and second pixels PXL1 and PXL2 may include first to third sub-pixels SP1, SP2, and SP3. However, embodiments are not limited thereto. For example, each of the first and second pixels PXL1 and PXL2 may include four sub-pixels or include two sub-pixels.

In FIG. 3, it is illustrated that the first to third sub-pixels SP1, SP2, and SP3 may have quadrangular shapes when viewed in a third direction DR3 intersecting the first and second directions DR1 and DR2, and have the same size. However, embodiments are not limited thereto. The first to third sub-pixels SP1, SP2, and SP3 may be modified to have various shapes.

The display panel DP may include a substrate SUB, a pixel circuit layer PCL, a light emitting element layer LDL, an encapsulation layer TFE, an optical functional layer OFL, an overcoat layer OC, and a cover window CW.

According to some embodiments, the substrate SUB may include a silicon wafer substrate formed using a semiconductor process. The substrate SUB may include a semiconductor material suitable for forming circuit elements. For example, the semiconductor material may include silicon, germanium, and/or silicon-germanium. The substrate SUB may be provided from a bulk wafer, an epitaxial layer, a Silicon On Insulator (SOI) layer, a Semiconductor On Insulator (SeOI) layer, or the like. According to some embodiments, the substrate SUB may include a glass substrate. According to some embodiments, the substrate SUB may include a polyimide (PI) substrate.

The pixel circuit layer PCL may be located on the substrate SUB. The substrate SUB and/or the pixel circuit layer PCL may include insulating layers and conductive patterns located between the insulating layers. The conductive patterns of the pixel circuit layer PCL may serve as at least some of circuit elements, lines, and the like. The conductive patterns may include copper, but embodiments are not limited thereto.

The circuit elements may include transistors and one or more capacitors of each of the first to third sub-pixels SP1, SP2, and SP3. Each transistor may include a semiconductor portion including a source region, a drain region, and a channel region, and a gate electrode overlapping with the semiconductor portion. According to some embodiments, when the substrate SUB is provided as a silicon substrate, the semiconductor portion may be included in the substrate SUB, and the gate electrode may be included as a conductive pattern of the pixel circuit layer PCL in the pixel circuit layer PCL. According to some embodiments, when the substrate SUB is provided as a glass substrate or a PI substrate, the semiconductor portion and the gate electrode may be included in the pixel circuit layer PCL. Each capacitor may include electrodes spaced apart from each other. For example, each capacitor may include electrodes spaced apart from each other on a plane defined by the first and second directions DR1 and DR2. For example, the capacitor may include electrodes spaced apart from each other in the third direction DR3 with an insulating layer interposed therebetween.

The lines of the pixel circuit layer PCL may include signal lines, e.g., a gate line, an emission control line, a data line, and the like, which are connected to each of the first to third sub-pixels SP1, SP2, and SP3. The lines may further include a line connected to the first power voltage VDD shown in FIG. 1. The lines may further include a line connected to the second power voltage VSS shown in FIG. 1.

The light emitting element layer LDL may include anode electrodes AE, a pixel defining layer PDL, a light emitting structure EMS, and a cathode electrode CE.

The anode electrodes AE may be located on the pixel circuit layer PCL. The anode electrodes AE may be in contact with the circuit elements of the pixel circuit layer PCL. The anode electrodes AE may include an opaque conductive material capable of reflecting light, but embodiments are not limited thereto.

The pixel defining layer PDL may be arranged over the anode electrodes AE. The pixel defining layer PDL may include an opening OP exposing a portion of each of the anode electrodes AE. The opening OP of the pixel defining layer PDL may be understood as an emission area corresponding to each of the first to third sub-pixels SP1 to SP3.

According to some embodiments, the pixel defining layer PDL may include an inorganic material. The pixel defining layer PDL may include a plurality of stacked inorganic layers. For example, the pixel defining layer PDL may include silicon oxide (SiOₓ) and silicon nitride (SiNₓ). According to some embodiments, the pixel defining layer PDL may include an organic material. However, the material of the pixel defining layer PDL is not limited thereto.

The light emitting structure EMS may be located on the anode electrodes AE exposed by the openings OP of the pixel defining layer PDL. The light emitting structure EMS may include a light emitting layer configured to generate light, an electron transport layer configured to transport electrons, a hole transport layer configured to transport holes, and the like.

According to some embodiments, the light emitting structure EMS fills the opening OP of the pixel defining layer PDL, and may be entirely arranged on the top of the pixel defining layer PDL. In other words, the light emitting structure EMS may extend throughout the first to third sub-pixels SP1 to SP3. At least some of the layers in the light emitting structure EMS may be cut or bent at boundaries between the first to third sub-pixels SP1 to SP3. However, embodiments are not limited thereto. For example, portions of the light emitting structure EMS, which correspond to the first to third sub-pixels SP1 to SP3, may be separated from each other, and each of the portions may be located in the opening OP of the pixel defining layer PDL.

The cathode electrode CE may be located on the light emitting structure EMS. The cathode electrode CE may extend throughout the first to third sub-pixels SP1, SP2, and SP3. As such, the cathode electrode CE may be provided as a common electrode for the first to third sub-pixels SP1, SP2, and SP3.

The cathode electrode CE may be a thin metal layer having a thickness to a degree to which light emitted from the light emitting structure EMS can be transmitted therethrough. The cathode electrode CE may be formed of a metal material to have a relatively thin thickness or be formed of a transparent conductive material. According to some embodiments, the cathode electrode CE may include at least one of various transparent conductive materials including indium tin oxide, indium zinc oxide, indium tin zinc oxide, aluminum zinc oxide, gallium zinc oxide, zinc tin oxide, or gallium tin oxide. According to some embodiments, the cathode electrode CE may include at least one of silver (Ag), magnesium (Mg), or mixtures thereof. However, the material of the cathode electrode CE is not limited thereto.

It may be understood that any one of the anode electrodes AE, a portion of the light emitting structure EMS, which overlaps therewith, and a portion of the cathode electrode CE, which overlaps therewith, constitute one light emitting element LD. In other words, each of light emitting elements of the first to third sub-pixels SP1 to SP3 may include one anode electrode AE, a portion of the light emitting structure EMS, which overlaps therewith, and a portion of the cathode electrode CE, which overlaps therewith. In each of the first to third sub-pixels SP1 to SP3, holes injected from the anode electrode AE and electrons injected from the cathode electrode CE may be transported into a light emitting layer of the light emitting structure EMS to form excitons, and light may be generated when the excitons are changed from an excited state to a ground state. A luminance of the light may be determined according to an amount of current flowing through the light emitting layer. A wavelength band of the generated light may be determined according to a configuration of the light emitting layer.

The encapsulation layer TFE may be arranged over the cathode electrode CE. The encapsulation layer TFE may cover the light emitting element layer LDL and/or the pixel circuit layer PCL. The encapsulation layer TFE may be configured to prevent or reduce instances of contaminants such as oxygen and/or moisture infiltrating into the light emitting element layer LDL. According to some embodiments, the encapsulation layer TFE may include a structure in which at least one inorganic layer and at least one organic layer are alternately stacked. For example, the inorganic layer may include silicon nitride, silicon oxide, silicon oxynitride (SiOₓN_{y}), or the like. For example, the organic layer may include an organic insulating material such as acrylic resin, epoxy resin, phenolic resin, polyamide resin, polyimide resin, unsaturated polyester resin, polyphenylene resin, polyphenylenesulfide resin, or benzocyclobutene (BCB). However, the materials of the organic layer and the inorganic layer of the encapsulation layer TFE are not limited thereto.

In order to relatively improve encapsulation efficiency of the encapsulation layer TFE, the encapsulation layer TFE may further include a thin film including aluminum oxide (AlOₓ). The thin film including the aluminum oxide may be located on a top surface of the encapsulation layer TFE, which faces the optical functional layer OFL, and/or a bottom surface of the encapsulation layer TFE, which faces the light emitting element layer LDL.

The thin film including the aluminum oxide may be formed through an Atomic Layer Deposition (ALD) process. However, embodiments are not limited thereto. The encapsulation layer TFE may further include a thin film formed of at least one of various materials suitable for the improvement of the encapsulation efficiency.

The optical functional layer OFL may be located on the encapsulation layer TFE. The optical functional layer OFL may include a color filter layer CFL and a lens array LA.

The color filter layer CFL may be located between the encapsulation layer TFE and the lens array LA. The color filter layer CFL may be configured to filter light emitted from the light emitting structure EMS, thereby selectively outputting light of a wavelength band or a color, which corresponds to each sub-pixel. The color filter layer CFL may include color filters CF respectively corresponding to the first to third sub-pixels SP1 to SP3. Each of the color filters CF may allow light having a wavelength band corresponding to a corresponding sub-pixel to pass therethrough.

For example, a color filter corresponding to the first sub-pixel SP1 may allow light of a red color to pass therethrough, a color filter corresponding to the second sub-pixel SP2 may allow light of a green color to pass therethrough, and a color filter corresponding to the third sub-pixel SP3 may allow light of a blue color to pass therethrough. According to light emitted from the light emitting structure EMS in each sub-pixel, at least some of the color filters CF may be omitted.

The lens array LA may be located on the color filter layer CFL. The lens array LA may include lenses LS respectively corresponding to the first to third sub-pixels SP1 to SP3. Each of the lenses LS may output light emitted from the light emitting structure EMS along an intended path, thereby relatively improving light emission efficiency. The lens array LA may have a relatively high refractive index. For example, the lens array LA may have a refractive index higher than a refractive index of the overcoat layer OC. According to some embodiments, the lenses LS may include an organic material. According to some embodiments, the lenses LS may include an acryl-based material. However, the material of the lenses LS is not limited thereto. In some embodiments, the lens array LA may be omitted.

The overcoat layer OC may be arranged over the lens array LA. The overcoat layer OC may cover the optical functional layer OFL, the encapsulation layer TFE, the light emitting structure EMS, and/or the pixel circuit layer PCL. The overcoat layer OC may include various materials suitable for protecting lower layers thereof from foreign matters such as dust and moisture. For example, the overcoat layer OC may include at least one of an inorganic insulating layer or an organic insulating layer. For example, the overcoat layer OC may include epoxy, but embodiments are not limited thereto. The overcoat layer OC may have a refractive index lower than a refractive index of the lens array LA.

The cover window CW may be located on the overcoat layer OC. The cover window CW may be configured to protect lower layers thereof. The cover window CW may have a refractive index higher than the refractive index of the overcoat layer OC. The cover window CW may include glass, but embodiments are not limited thereto. For example, the cover window CW may be an encapsulation glass configured to protect components located thereunder. According to some embodiments, the cover window CW may be omitted.

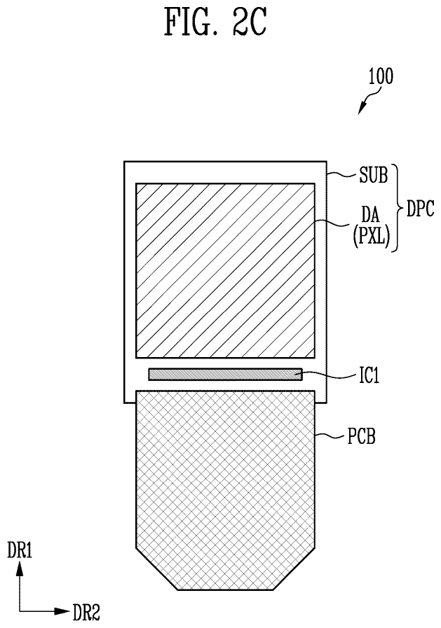

FIG. 4 is a diagram illustrating aspects of components of the data driver shown in FIG. 1.

Referring to FIG. 4, the data driver 130 may include a shift register 310, a sampling latch 320, a holding latch 330, a decoder 340, a buffer 350, and the like.

The shift register 310 (or shift register unit) may sequentially generate n sampling signals in response to a source start pulse SSP and a source shift clock SSC. Specifically, the shift register 310 may sequentially generate n sampling signals while shifting the source start pulse SSP for each cycle of the source shift clock SSC. The shift register 310 may include n shift registers 3101 to 310n.

The sampling latch 320 (or sampling latch unit) may sequentially latch (or store) image data in response to the sampling signals sequentially supplied from the shift register 310. The sampling latch 320 may include n sampling latches 3201 to 320n configured to store n image data DATA.

The holding latch 330 (or holding latch unit) may latch (or store) an output of the sampling latch 320, i.e., the image data DATA output from the sampling latch 320 in response to a source output enable signal SOE. The holding latch 330 may supply the stored image data DATA to the decoder 340. The holding latch 330 may include n holding latches 3301 to 330n.

The decoder 340 (or digital-to-analog converter) may convert an output of the holding latch 330, i.e., the image data DATA output from the holding latch 330 into an analog signal (e.g., an analog voltage). The decoder 340 may output the converted analog signal to the buffer 350. The decoder 340 may receive a minimum grayscale gamma voltage VGAL and a maximum grayscale gamma voltage VGAH. The decoder 340 may select grayscale voltages corresponding to the image data DATA input from the holding latch 330, based on the received minimum grayscale gamma voltage VGAL and the received maximum grayscale gamma voltage VGAH. The decoder 340 may include n digital-to-analog converters 3401 to 340n. The decoder 340 may generate n data voltages, using the digital-to-analog converters 3401 to 340n arranged corresponding to each channel (e.g., each data line), and supply the generated data voltages to the buffer 350.

The buffer 350 may supply the n data voltages supplied from the decoder 340 to n data lines DL1 to DLn. The buffer 350 may include n amplifiers 3501 to 350n.

The n shift registers 3101 to 310n, the n sampling latches 3201 to 320n, the n holding latches 3301 to 330n, the n digital-to-analog converters 3401 to 340n, and the n amplifiers 3501 to 350n may constitute n stages ST1 to STn. For example, a first shift register 3101, a first sampling latch 3201, a first holding latch 3301, a first digital-to-analog converter 3401, and a first amplifier 3501 may constitute a first stage ST1.

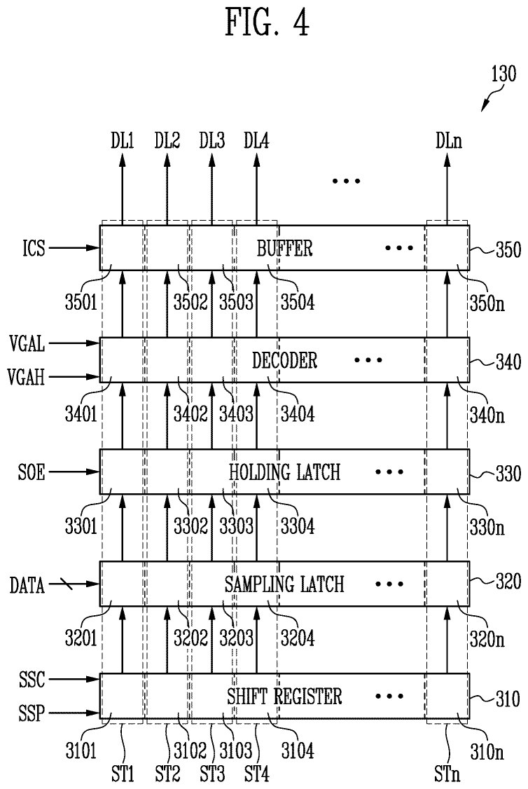

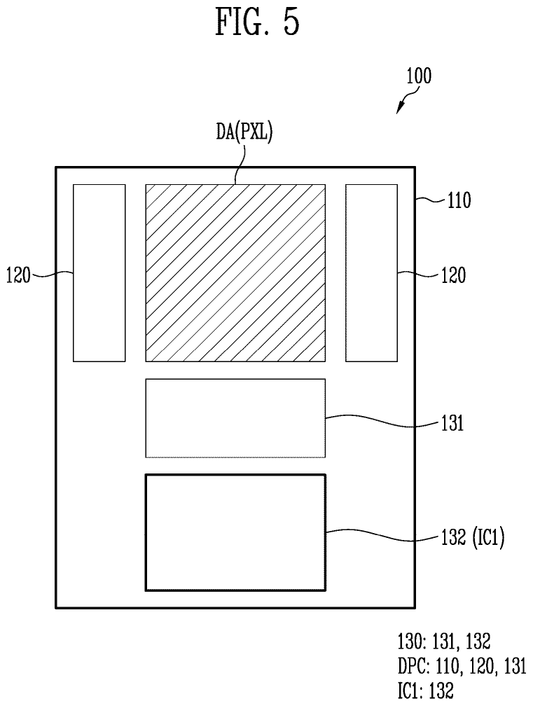

FIG. 5 is a plan view illustrating aspects of the display device shown in FIG. 1 according to some embodiments. FIGS. 6 and 7 are block diagrams illustrating aspects of a data driver included in the display device shown in FIG. 5 according to some embodiments.

First, referring to FIGS. 1, 2A to 2C, and 5, the display device 100 may include a display panel 110, a gate driver 120, and a data driver 130. The display panel 110, the gate driver 120, and the data driver 130 have been described with reference to FIGS. 1 and 2A to 2C, and therefore, overlapping descriptions will be omitted.

At least one pixel PXL may be located in a display area DA of the display panel 110. The pixel PXL may be connected to a data line and a gate line. The display panel 110 may be implemented as a panel chip DPC.

The gate driver 120 may be located at one side and an opposite side. However, the gate driver 120 is not limited thereto. The gate driver 120 may provide a gate signal to the pixel PXL through the gate line. The gate driver 120 may be implemented in the display panel 110, but the present disclosure is not limited thereto.

The data driver 130 may provide a data signal to the pixel PXL through the data line.

The data driver 130 may include a first circuit 131 (or first block) and a second circuit 132 (or second block). The first circuit 131 may include some components of the data driver 130, including the buffer 350 (see FIG. 4), and the second circuit 132 may include the other components of the data driver 130, including the sampling latch 320 (see FIG. 4).

According to some embodiments, the first circuit 131 may include a high voltage element having a low node level, and the second circuit 132 may include only a low voltage element having a high node level.

According to some embodiments, the first circuit 131 of the data driver 130 may be implemented in the display panel 110 or be integrated or formed together with the display panel 110 in the panel chip DPC. The second circuit 132 of the data driver 130 may be integrated or formed in a first integrated circuit IC1 (or first chip) different from the display panel 110 or the panel chip DPC. The panel chip DPC may include only a high voltage element having a low node level, and the first integrated circuit IC1 may include only a low voltage element having a high node level. The first integrated circuit IC1 may not include the high voltage element. For example, the panel chip DPC may include only a CMOS circuit element having about 8V, about 5V, or about 3V, and the first integrated circuit IC1 may include only a COMS circuit element having about 1.1V or about 1.8V.

Referring to FIGS. 6 and 7, the second circuit 132 may include a shift register 310 and a sampling latch 320. Also, the second circuit 132 may further include an interface 305 (or receiver) connected to a front end of the shift register 310. The interface 305 may receive image data provided from the controller 150. The shift register 310, the sampling latch 320, and the interface 305 may be implemented with a low voltage element or include only a low voltage element.

The first circuit 131 may include a holding latch 330, a decoder 340, and a buffer 350. The holding latch 330, the decoder 340, and the buffer 350 may be implemented with a high voltage element or include only a high voltage element.

A high voltage of about 3V or higher is required to drive the display panel 110 (or the pixel PXL), and hence the buffer 350 (or amplifier) is to be implemented with a high voltage element. While a general decoder may be implemented with a low voltage element or a high voltage element, the decoder 340 according to some embodiments of the present disclosure may be implemented with a high voltage element. When the decoder 340 is implemented with a high voltage element (or when the decoder 340 is built in the panel chip DPC), the holding latch 330 which holds a digital value provided to the decoder 340 may also be implemented with a high voltage element to be built in the panel chip DPC. A MUX (or multiplexer) and a DEMUX (or demultiplexer) may be used to decrease a number of pads between the first integrated circuit IC1 and the panel chip DPC. When a MUX and a DEMUX (e.g., a 16:1 multiplexer and a 1:16 demultiplexer), which have a high input/output ratio, are connected between the decoder 340 and the holding latch 330, it may be difficult for the entire output of the holding latch 330 to be stably transferred to the decoder 340 within a limited time (e.g., one horizontal time). Therefore, the holding latch 330 along with the decoder 340 may be implemented with a high voltage element to be built in the panel chip DPC.

According to some embodiments, the first circuit 131 may further include a level shifter 325 connected between the sampling latch 320 and the holding latch 330. The level shifter 325 may convert a voltage level (or voltage width) of an input signal and output the input signal. For example, the level shifter 325 may convert a low voltage output from the sampling latch 320 into a high voltage and provide the high voltage to the holding latch 330. The level shifter 325 may be implemented with a high voltage element to be built in the panel chip DPC.

According to some embodiments, the first circuit 131 may further include a second MUX 430 (or second multiplexer) connected between the holding latch 330 and the decoder 340. The second MUX 430 may select a signal output from the holding latch 330 and provide the selected signal to the decoder 340. For example, the second MUX 430 may be a 1:1 multiplexer or a 3:1 multiplexer. When the second MUX 430 is provided, the size or number of the decoder 340 may be decreased. A second DEMUX 440 (or second demultiplexer) may be provided at a rear end of the buffer 350, corresponding to the second MUX 430. For example, the second DEMUX 440 may be connected between the buffer 350 and the pixel PXL (or the data line). The second DEMUX 440 may be integrated or formed in the display panel 110.

According to some embodiments, the second circuit 132 may further include a first MUX 410 (or first multiplexer) connected between the sampling latch 320 and the first circuit 131, and the first circuit 131 may further include a first DEMUX 420 (or first demultiplexer) connected between the second circuit 132 and the level shifter 325. The first MUX 410 may be formed in the first integrated circuit IC1, and the first DEMUX 420 may be formed in the panel chip DPC. Unlike that one analog signal requires one pad, one digital value (or digital voltage value) may require pads of which number corresponds to a data bit number (e.g., 8 pads for an 8-bit data value). The first MUX 410 and the first DEMUX 420 may decrease the number of pads between the first integrated circuit IC1 and the panel chip DPC.

For example, when the sampling latch 320 and the holding latch 330 use an 8-bit data value, the first MUX 410 may select and output at least 8 inputs, and the first DEMUX 420 may output one input as at least 8 inputs. For example, when the pixels PXL are arranged in a PENTILET structure in the display area DA and when the second MUX 420 is a 2:1 multiplexer, the first MUX 410 may be a 16:1 multiplexer, and the first DEMUX 420 may be a 1:16 demultiplexer. According to some embodiments, when the pixels PXL are arranged in an RGB structure in the display area DA and when the second MUX 430 is a 3:1 multiplexer, the first MUX 410 may be a 24:1 multiplexer, and the first DEMUX 420 may be 1:24 demultiplexer.

As described above, some components of the data driver 130, including the buffer 350 implemented with a high voltage element, may be integrated or formed in the panel chip DPC, and the other components of the data driver 130, including the sampling latch 320 implemented with a low voltage element, may be integrated or formed in the first integrated circuit IC1. Thus, cost of the first integrated circuit IC1 including only the low voltage element can be relatively reduced, as compared with a chip including both the high voltage element and the low voltage element.

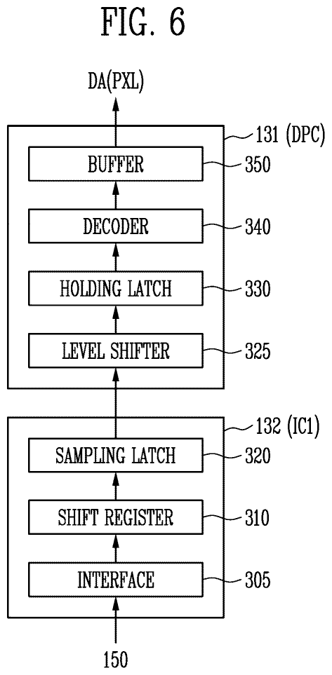

FIG. 8 is a block diagram illustrating a comparative example of the data driver included in the display device shown in FIG. 5.

Referring to FIGS. 5 to 8, a data driver 130_C may be configured as one chip or one integrated circuit IC_C.

The data driver 130_C may include an interface 305, a shift register 310, a sampling latch 320, a holding latch 330_C, a second MUX 430_C, a level shifter 325_C, a decoder 340, and a buffer 350. The interface 305, the shift register 310, the sampling latch 320, and the holding latch 330_C may be implemented with a low voltage element, and the second MUX 430_C, the level shifter 325_C, the decoder 340, and the buffer 350 may be implemented with a high voltage element.

The second MUX 430_C may select an output of the holding latch 330_C and provide the selected output to the level shifter 325_C, and the level shifter 325_C may convert a voltage level of the output of the holding latch 330_C from a low voltage to a high voltage and provide the converted output to the decoder 340.

Because the integrated circuit IC_C in accordance with the comparative example includes both the low voltage element and the high voltage element, cost of the integrated circuit IC_C may be expensive, as compared with an integrated circuit including only a single element (e.g., the high voltage element). Therefore, according to some embodiments, some components including the buffer 350 implemented with the high voltage element may be integrated or formed in the panel chip DPC (see FIG. 5), and the first integrated circuit IC1 (see FIG. 5) may include only the low voltage element. Accordingly, cost of the first integrated circuit IC1 (and the display device 100) can be relatively reduced.

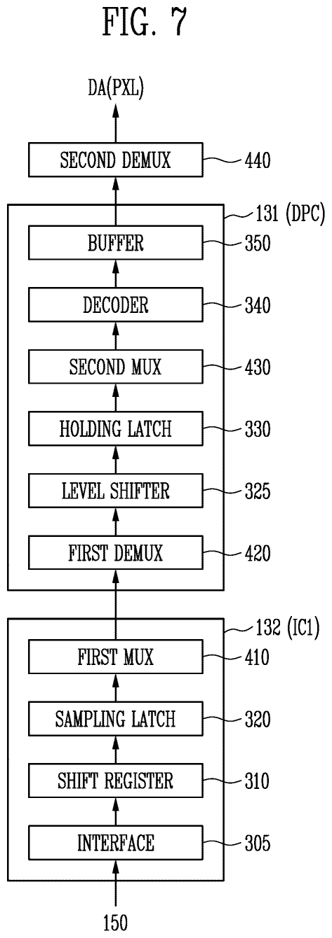

FIG. 9 is a block diagram illustrating aspects of the data driver included in the display device shown in FIG. 5 according to some embodiments.

Referring to FIGS. 5 and 9, a second circuit 132_1 may include a shift register 310, a sampling latch 320, a holding latch 330_1, and a decoder 340_1. Also, the second circuit 132_1 may further include an interface 305 (or receiver) connected to a front end of the shift register 310.

The decoder 340_1 may be implemented with a low voltage element or including only a low voltage element. Unlike the decoder 340 shown in FIGS. 6 and 7, the decoder 340_1 may be integrated or formed in the first integrated circuit IC1. Because the size (or area) of the decoder 340_1 is large, it may be determined where (e.g., in the first integrated circuit IC1 or the panel chip DPC) the decoder 340_1 is advantageously integrated, by considering cost and yield of the first integrated circuit IC1. Accordingly, the decoder 340_1 may be formed in the first integrated circuit IC1.

As the decoder 340_1 is formed in the first integrated circuit IC1, the holding latch 330_1 connected between the sampling latch 320 and the decoder 340_1 may also be integrated or formed in the first integrated circuit IC1. The holding latch 330_1 may be implemented with a low voltage element or include only a low voltage element.

A first circuit 131_1 may include a buffer 350. Also, the first circuit 131_1 may further include a level shifter 325_1 connected between the decoder 340_1 and the buffer 350. The level shifter 325_1 may convert a low voltage output from the decoder 340_1 into a high voltage and provide the converted high voltage to the buffer 350. The level shifter 325_1 may be implemented with a high voltage element to be built in the panel chip DPC.

As described above, the decoder 340_1 may be implemented with a low voltage element to be integrated or formed in the first integrated circuit IC1, and only the buffer 350 and the level shifter 325_1, which are implemented with a high voltage element, may be integrated or formed in the panel chip DPC.

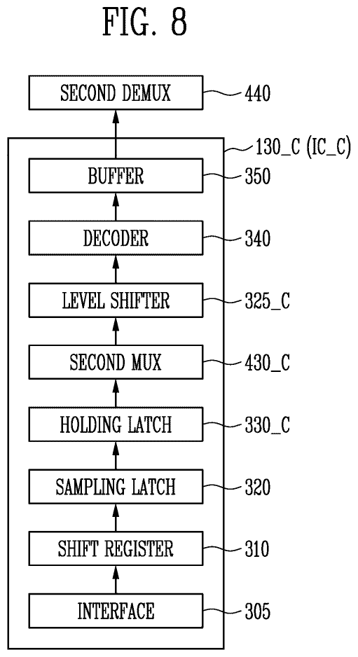

FIG. 10 is a block diagram illustrating aspects of the data driver included in the display device shown in FIG. 5.

Referring to FIGS. 5, 6, and 10, the embodiments shown in FIG. 10 may be identical or substantially identical or similar to the embodiments shown in FIG. 6, except a position of a holding latch 330_2. Therefore, some overlapping descriptions may be omitted.

A second circuit 132_2 may include a shift register 310, a sampling latch 320, and the holding latch 330_2, and a first circuit 131_2 may include a level shifter 325_2, a decoder 340, and a buffer 350.

As described with reference to FIGS. 6 and 7, a MUX and a DEMUX may be used to decrease the number of pads between the first integrated circuit IC1 and the panel chip DPC. However, when the MUX and the DEMUX are connected between the decoder 340 and the holding latch 330, it may be difficult for the output of the holding latch 330 to be stably transferred to the decoder 340 within a limited time (e.g., one horizontal time).

However, for example, when it is unnecessary to decrease the number of pads, accordingly, when the MUX and the DEMUX (e.g., the first MUX 410 and the first DEMUX, which are shown in FIG. 7) are not connected between the decoder 340 and the holding latch 330_2, the holding latch 330_2 may be implemented with a low voltage element to be integrated or formed in the first integrated circuit IC1. According to some embodiments, when the limited time (e.g., the one horizontal time) is sufficient, the holding latch 330_2 may be implemented with a low voltage element to be integrated or formed in the first integrated circuit IC1 even though the MUX and the DEMUX are connected between the decoder 340 and the holding latch 330_2.

The level shifter 325_2 may be connected between the holding latch 330_2 and the decoder 340. The level shifter 325_2 may convert a low voltage output from the holding latch 330_2 into a high voltage and provide the converted high voltage to the decoder 340. The level shifter 325_2 may be implemented with a high voltage element to be built in the panel chip DPC.

As described above, the buffer 350 and the decoder 340 may be implemented with a high voltage element to be integrated or formed in the panel chip DPC, and the holding latch 330_2 may be implemented with a low voltage element to be integrated or formed in the first integrated circuit IC1.

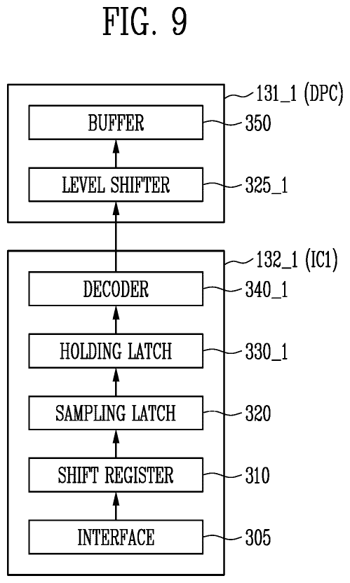

FIG. 11 is a block diagram illustrating aspects of a display system according to some embodiments.

Referring to FIG. 11, a display system 1000 (or electronic device) may include a processor 1100 and a display device 1200.

The processor 1100 may perform various tasks and various calculations. According to some embodiments, the processor 1100 may include an Application Processor (AP), a Graphics Processing Unit (GPU), a microprocessor, a Central Processing Unit (CPU), and the like. The processor 1100 may be connected to other components of the display system 1000 through a bus system to control the components of the display system 1000.

The processor 1100 may transmit image data IMG and a control signal CTRL to the display device 1200. The display device 1200 may display an image, based on the image data IMG and the control signal CTRL. The display device 1200 may be configured identically to the display device 10 described with reference to FIG. 1. The image data IMG and the control signal CTRL may be provided as the input image data IMG and the control signal CTRL, which are shown in FIG. 1, respectively.

The display system 1000 may include a computing system for providing an image display function, such as a smart watch, a mobile phone, a smartphone, a portable computer, a tablet personal computer (PC), a watch phone, an automotive display, a smart glass, a portable multimedia player (PMP), a navigation system, or an ultra mobile computer (UMPC). The display system 1000 may include at least one of a head mounted display (HMD) device, a virtual reality (VR) device, a mixed reality (MR) device, or an augmented reality (AR) device.

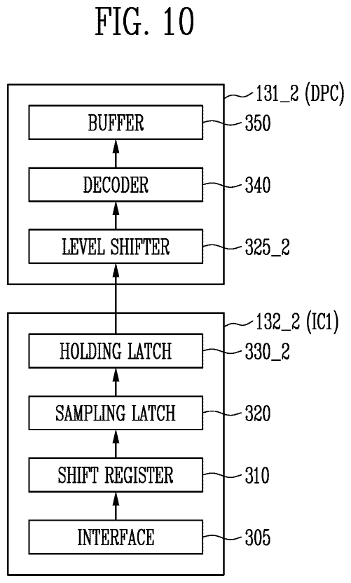

FIGS. 12 to 14 are perspective views illustrating application examples of the display system shown in FIG. 11.

Referring to FIG. 12, the display system 1000 shown in FIG. 11 may be applied to a smart watch 2000 including a display part 2100 and a strap part 2200.

The smart watch 2000 may be a wearable electronic device. For example, the smart watch 2000 may have a structure in which the strap part 2200 is mounted on a wrist of a user. The display system 1000 and/or the display device 1200 may be applied to the display part 2100, so that image data including time information can be provided to the user.

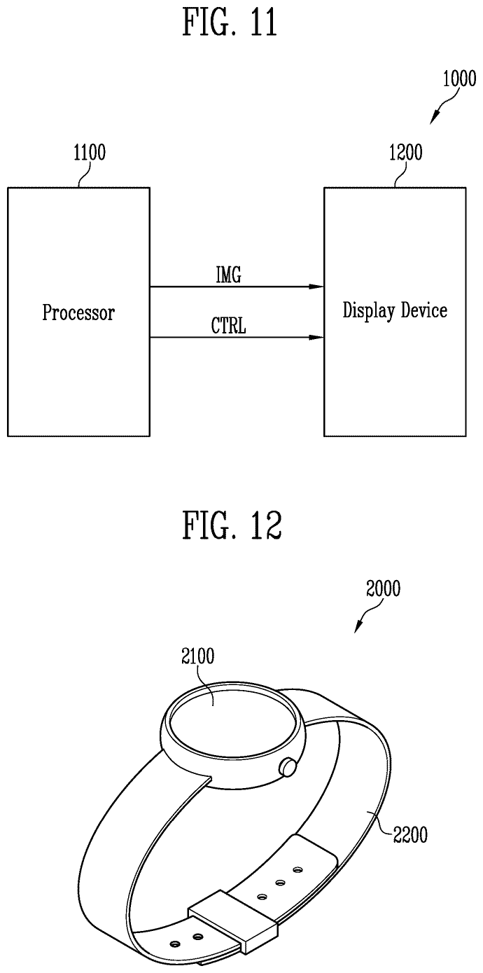

Referring to FIG. 13, the display system 1000 shown in FIG. 11 may be applied to smart glasses 4000. The smart glasses 4000 are a wearable electronic device which can be worn on the face of a user. For example, the smart glasses 4000 may be a wearable device for Augmented Reality (AR).

The smart glasses 4000 may include a frame 4100 and a lens part 4200. The frame 4100 may include a housing 4110 supporting the lens part 4200 and a leg part 4120 for allowing the user to wear the smart glasses 4000. The leg part 4120 may be connected to the housing 4110 through a hinge, to be folded or unfolded with respect to the housing 4110.

A battery, a touch pad, a microphone, a camera, and the like may be built in the frame 4100. In addition, a projector for outputting light, a processor for controlling a light signal, and the like may be built in the frame 4100.

The lens part 4200 may be an optical member which allows light to be transmitted therethrough or allows light to be reflected thereby. For example, the lens part 4200 may include glass, transparent synthetic resin, and the like.

In order to enable eyes of the user to recognize visual information, the lens part 4200 may allow an image caused by a light signal transmitted from the projector of the frame 4100 to be reflected by a rear surface (e.g., a surface in a direction facing the eyes of the user) of the lens part 4200. For example, the user may recognize information including time, data, and the like, which are displayed on the lens part 4200. The projector and/or the lens part 4200 may be a kind of display device. The display device 1200 may be applied to the projector and/or the lens part 4200.

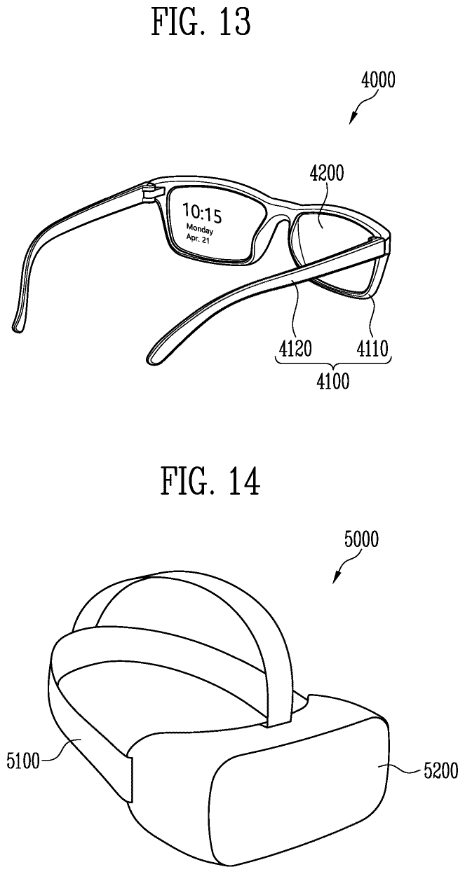

Referring to FIG. 14, the display system 1000 shown in FIG. 11 may be applied to a head mounted display device 5000.

The head mounted display device 5000 may be a wearable electronic device which can be worn on the head of a user. For example, the head mounted display device 5000 may be a wearable device for virtual reality (VR) or mixed reality (MR).

The head mounted display device 5000 may include a head mounted band 5100 and a display accommodating case 5200. The head mounted band 5100 may be connected to the display accommodating case 5200. The head mounted band 5100 may include a horizontal band and/or a vertical band, used to fix the head mounted display device 5000 to the head of the user. The horizontal band may be configured to surround a side portion of the head of the user, and the vertical band may be configured to surround an upper portion of the head of the user. However, embodiments are not limited thereto. For example, the head mounted band 5100 may be implemented in the form of a glasses frame, a helmet or the like.

The display device accommodating case 5200 may accommodate the display system 1000 and/or the display device 1200.

In the display device and the electronic device including the same according to some embodiments of the present disclosure, some components of the data driver, including a buffer implemented with a high voltage element, may be integrated or formed in the display panel (or the panel chip), and the other components of the data driver, including a sampling latch implemented with a low voltage element, may be integrated or formed in the first integrated circuit. Thus, cost of the first integrated circuit including only the low voltage element and the display device and the electronic device, which include the first integrated circuit, can be relatively reduced.

Aspects of some embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims, and their equivalents.

What is claimed is:

1. A display device comprising:
a display panel including a pixel connected to a data line, the display panel being configured to display an image; and
a data driver configured to provide a data signal to the data line,
wherein the data driver includes:
a shift register configured to generate a sampling signal;
a sampling latch configured to latch image data in response to the sampling signal;
a holding latch configured to store an output of the sampling latch;
a decoder configured to convert an output of the holding latch into an analog signal; and
a buffer configured to provide an output of the decoder to the data line, and
wherein the sampling latch is integrated in a first chip different from the display panel, and
wherein the buffer is integrated in the display panel.

2. The display device of claim 1, wherein the first chip includes a low voltage element having a node level higher than a node level of a high voltage element integrated in the display panel, and does not include the high voltage element.

3. The display device of claim 2, wherein the display panel is implemented as a chip different from the first chip.

4. The display device of claim 1, wherein the decoder and the holding latch are integrated together with the buffer in the display panel.

5. The display device of claim 4, wherein the data driver further includes a level shifter connected between the sampling latch and the holding latch, and
wherein the level shifter is integrated in the display panel.

6. The display device of claim 5, wherein the data driver further includes a first multiplexer and a first demultiplexer, which are connected between the sampling latch and the level shifter, and
wherein the first multiplexer is integrated in the first chip, and
wherein the first demultiplexer is integrated in the display panel.

7. The display device of claim 1, wherein the holding latch and the decoder are integrated in the first chip.

8. The display device of claim 7, wherein the data driver further includes a level shifter connected between the decoder and the buffer, and
wherein the level shifter is integrated in the display panel.

9. The display device of claim 1, further comprising a timing controller configured to provide image data to the data driver,
wherein the timing controller is integrated in a second chip different from the first chip.

10. The display device of claim 1, further comprising a timing controller configured to provide image data to the data driver,
wherein the timing controller is integrated in the first chip.

11. A display device comprising:
a display panel including a pixel connected to a data line, the display panel being configured to display an image; and
a data driver configured to provide a data signal to the data line,
wherein the data driver includes:
a shift register configured to generate a sampling signal;
a sampling latch configured to latch image data in response to the sampling signal;
a holding latch configured to store an output of the sampling latch;
a decoder configured to convert an output of the holding latch into an analog signal; and
a buffer configured to provide an output of the buffer to the data line, and
wherein the data driver further includes a level shifter electrically connected between the sampling latch and the holding latch.

12. The display device of claim 11, wherein the sampling latch is implemented with a low voltage element, and
wherein the level shifter and the holding latch are implemented with a high voltage element having a node level lower than a node level of the low voltage element.

13. The display device of claim 11, wherein the data driver further includes a first multiplexer and a first demultiplexer, which are connected between the sampling latch and the level shifter.

14. An electronic device comprising:
a processor configured to output input image data; and
a display device configured to display an image, based on the input image data,
wherein the display device includes:
a display panel including a pixel connected to a data line;
a timing controller configured to convert the input image data into image data corresponding to an arrangement of the pixel in the display panel; and
a data driver configured to generate a data signal, based on the image data, and provide the data signal to the data line,
wherein the data driver includes:
a shift register configured to generate a sampling signal;
a sampling latch configured to latch image data in response to the sampling signal;
a holding latch configured to store an output of the sampling latch;
a decoder configured to convert an output of the holding latch into an analog signal; and
a buffer configured to provide an output of the decoder to the data line, and
wherein the sampling latch is integrated in a first chip different from the display panel, and
wherein the buffer is integrated in the display panel.

15. The electronic device of claim 14, wherein the first chip includes a low voltage element having a node level higher than a node level of a high voltage element integrated in the display panel, and does not include the high voltage element.

16. The electronic device of claim 14, wherein the decoder and the holding latch are integrated together with the buffer in the display panel.

17. The electronic device of claim 16, wherein the data driver further includes a level shifter connected between the sampling latch and the holding latch, and
wherein the level shifter is integrated in the display panel.

18. The electronic device of claim 17, wherein the data driver further includes a first multiplexer and a first demultiplexer, which are connected between the sampling latch and the level shifter, and
wherein the first multiplexer is integrated in the first chip, and
wherein the first demultiplexer is integrated in the display panel.

19. The electronic device of claim 14, wherein the holding latch and the decoder are integrated in the first chip,
wherein the data driver further includes a level shifter connected between the decoder and the buffer, and
wherein the level shifter is integrated in the display panel.

20. The electronic device of claim 14, wherein the electronic device is one of a smart watch, a mobile phone, a smartphone, a portable computer, a tablet personal computer (PC), a watch phone, an automotive display, a smart glass, a portable multimedia player (PMP), a navigation system, or an ultra mobile computer (UMPC), a head mounted display (HMD) device, a virtual reality (VR) device, a mixed reality (MR) device, or an augmented reality (AR) device.
